(19) United States
(12) Patent Application Publication
(10) Pub. No.: US 2014/0367245 A1
(43) Pub. Date: Dec. 18, 2014

(54) OPTICAL EXCITATION OF CHEMICAL SPECIES FOR ENHANCED CHEMICAL REACTION

(71) Applicant: Roger R. Dube, Pittsford, NY (US)

(72) Inventor: Roger R. Dube, Pittsford, NY (US)

(21) Appl. No.: 14/302,328

(22) Filed: Jun. 11, 2014

Related U.S. Application Data
(60) Provisional application No. 61/833,764, filed on Jun. 11, 2013.

(51) Int. Cl. B01J 19/12

(52) U.S. Cl. CPC B01J 19/121
USPC 204/157.61

(57) ABSTRACT

An invention is provided for molecular excitation via monochromatic light at a particular wavelength. The invention includes providing a chemical to an illumination chamber, and illuminating the chemical with monochromatic light of a predefined wavelength. As a result, the chemical is placed in an excitation state that results in the molecules of the chemical being more likely to react with other molecules. Thereafter the chemical is provided to a reaction chamber, wherein the molecules of the chemical bond with other molecules in a predefined manner.

### CROSS REFERENCE TO RELATED APPLICATIONS

This application claims the benefit of U.S. Provisional Patent Application having Ser. No. 61/833,764, filed on Jun. 11, 2013, and entitled “Optical Excitation Of Chemical Species For Enhanced Chemical Reaction,” which is hereby incorporated by reference.

### BACKGROUND OF THE INVENTION

“Gas to Liquids” (GTL) is a term used to describe a variety of processes that convert an input gas (for example, methane) to a longer chain hydrocarbon (ideally, a liquid). The vast majority of GTL processes in use and under development today employ heat and physical catalysts. One such example is the Fischer-Tropsch (F-T) process, named after the two inventors of the process. The F-T process burns some of the source gas (natural gas, consisting primarily of methane) to heat up a chamber of natural gas, which is then allowed to come into contact with a physical catalyst. The rapid movements of the heated molecules increase the likelihood that they will encounter the catalyst. On the surface of the catalyst, the molecules have a lower activation potential—that is, the barrier to a reaction (such as the combining of two methane molecules) is reduced, and longer chain hydrocarbons are created at a much higher rate than would occur otherwise.

One drawback to this conventional approach to producing longer chain hydrocarbons is that the process is very inefficient. Large amounts of heat must be produced to achieve the throughputs desired.

A second drawback of this approach is that the catalyst “fatigues,” where oxidation and the gradual accumulation of impurities reduces its efficiency over time. The catalyst must be replaced or reconditioned, and this is both an expensive and time-consuming process that incurs great expense to the user.

A third drawback of the F-T process is that a reasonable return on investment can only be achieved for very large F-T facilities. This precludes building a transportable or small system that can be taken to remote sources of gas. Approximately one-third of all natural gas is said to be “stranded”—that is, it is located at a place where it cannot be accessed at a reasonable cost.

A fourth drawback of the F-T process is that it is not species-specific. That is, it is not possible to tune the process to produce a single final long chain hydrocarbon. By its very nature, it produces a wide distribution of hydrocarbons, thereby requiring the subsequent separation of these products using fractionation, another large, expensive process.

### SUMMARY OF THE INVENTION

Broadly speaking, embodiments of the present invention provide excitation via monochromatic light at a particular wavelength. In one embodiment, a method for optical excitation of chemical species for enhanced chemical reaction is disclosed. The method includes providing a chemical to an illumination chamber, and illuminating the chemical with monochromatic light of a predefined wavelength. As a result, the chemical is placed in an excitation state that results in the molecules of the chemical being more likely to react with other molecules. Thereafter the chemical is provided to a reaction chamber, wherein the molecules of the chemical bond with other molecules in a predefined manner.

### BRIEF DESCRIPTION OF THE DRAWINGS

The invention, together with further advantages thereof, may best be understood by reference to the following description taken in conjunction with the accompanying drawings in which:

FIG. 1 illustrates a system for optical excitation of chemical species for enhanced chemical reaction, in accordance with an embodiment of the present invention; and

FIG. 2 illustrates a system for optically exciting methane gas molecules into a longer chain hydrocarbon, such as propane, in accordance with an embodiment of the present invention.

### DETAILED DESCRIPTION OF THE EMBODIMENTS

Embodiments of the present invention relate to a system and method for enhanced chemical reactions via optical excitation of molecules. Excitation in the present disclosure refers to moving electrons from one orbital up to a higher level orbital. Embodiments of the present invention provide this excitation via monochromatic light at a particular wavelength.

Historically, photons have been used as an unsophisticated means to get molecules moving, such as spinning or vibrating. However, embodiments of the present invention use monochromatic light at a particular wavelength to find an excited state of a particular molecule that results in the molecule being more reactive for a reasonable amount of time. The molecules are then illuminated with the particular wavelength of monochromatic light to achieve enhanced reactions.

In this excited state, the molecules are more likely to react with other molecules. Random molecular motion of these molecules causes them to collide with other similarly excited molecules, and in some cases these collisions cause a chemical bonding. The specific wavelength of light that excites a molecule to such a state is based on the properties and atomic structure of the particular molecule, and can be different for different chemical reactions. It is possible that there might be intermediate states between the original molecule and the final reaction product. Such intermediate states may or may not be important to the overall process of optical conversion without detracting from the present invention. As such, embodiments of the present invention provide a system and method for enabling the rapid reaction of a chemical species with itself or other chemical species using carefully chosen wavelengths of light to enhance the reaction rate.

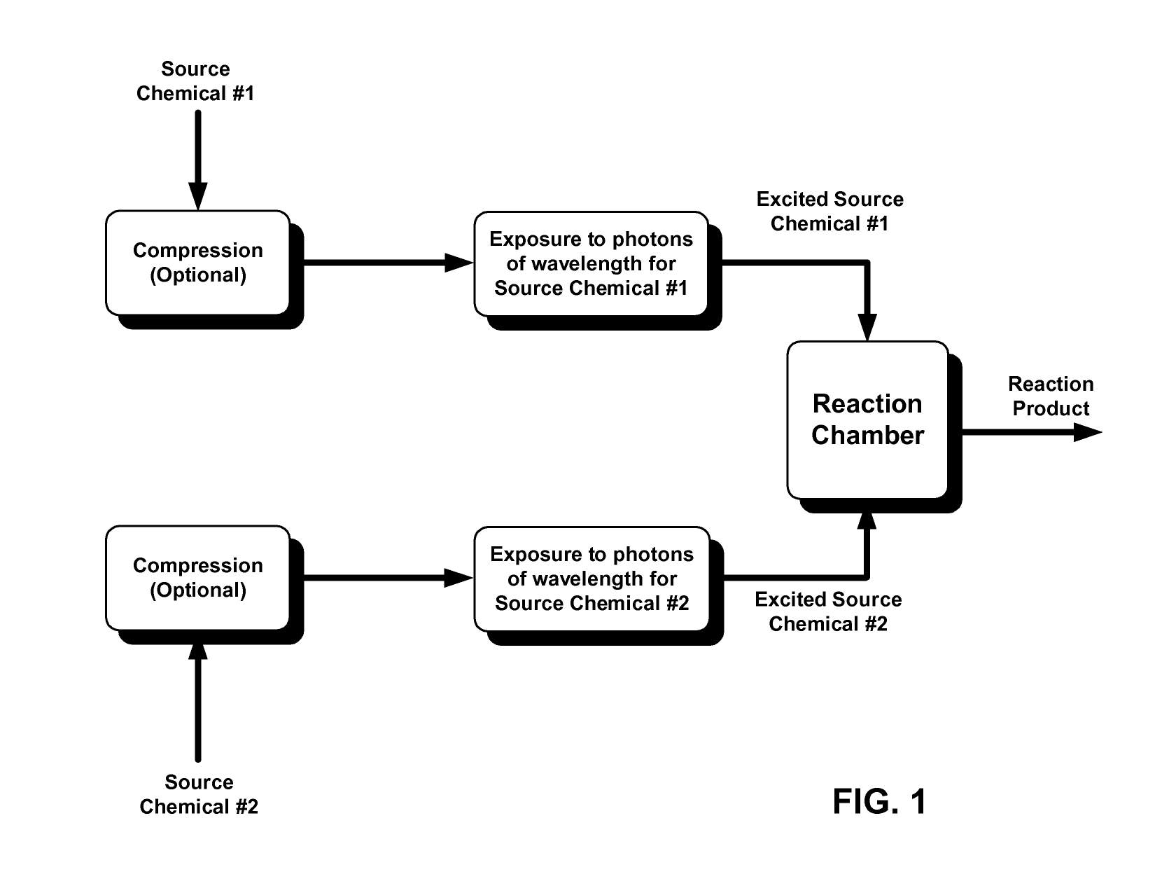

For example, FIG. 1 illustrates a system for optical excitation of chemical species for enhanced chemical reaction, in accordance with an embodiment of the present invention. As illustrated in FIG. 1, two source chemicals that are to be combined are provided to the system. These chemicals can be in any form, such as a gas or liquid, and can be different from one another. Optionally, one or both chemicals can be compressed for enhanced illumination and reaction, depending on the exact chemicals utilized and the needs of the particular system.

After the optional compression, the chemicals are provided to an illumination chamber where each chemical is illuminated by its own private excitation wavelength that results in the desired excitation state. For example, as will be described in greater detail subsequently, methane gas can be illuminated by monochromatic light at a wavelength of 421 nanometers (nm) to cause the methane gas to react to form longer chain hydrocarbons. In general, the desired excitation state results in the molecules of the particular chemical to bond in a desired manner with the molecules of the other chemical provided to the system.

For example, in the example of FIG. 1, source chemical 1 is illuminated by light, generally monochromatic light at a particular wavelength 1. Simultaneously, source chemical 2 is illuminated by monochromatic light of wavelength 2. In one embodiment, wavelength 1 selectively excites chemical 1, while wavelength 2 selectively excites chemical 2. The excited species of chemical 1 and chemical 2 then are allowed to mix with one another, such that the molecules of source chemical 1 bond with the molecules of source chemical 2 in a desired manner. This reaction chamber may be coincident with the two excitation chambers, or may be a separate, subsequent chamber, depending on the lifetimes of the excited states and the flow rate of the species, as can be appreciated by one practiced in the art. Upon colliding, some fraction of the excited source chemicals is provided to a reaction chamber where the molecules of the excited source chemicals bond in the desired manner to form the reaction product.

As will be appreciated by those skilled in the art after a careful reading of the present disclosure, embodiments of the present invention are highly efficient, use low energy consuming solid-state lasers, obviate the need for physical catalysts, and can operate on a small scale that is potentially transportable to remote locations. For example, embodiments of the present invention can be implemented as modules that are subsequently chained in sequence to create a system that converts a source gas (such as natural gas) to a target longer chain hydrocarbon (such as butane, gasoline, or diesel fuel). The present invention describes a system that achieves this goal through the use of carefully selected light sources (ideally, low cost, compact solid state lasers) and a supporting excitation/reaction system that allows the extraction of a final reaction product from the system right on site. Moreover, embodiments of the present invention can be applied to reactants in a liquid state, as well as a gas state. In addition to combining multiple chemicals, embodiments of the present invention can be utilized for unification of a single chemical to produce longer molecular chains that are more attractive than the original source molecule.

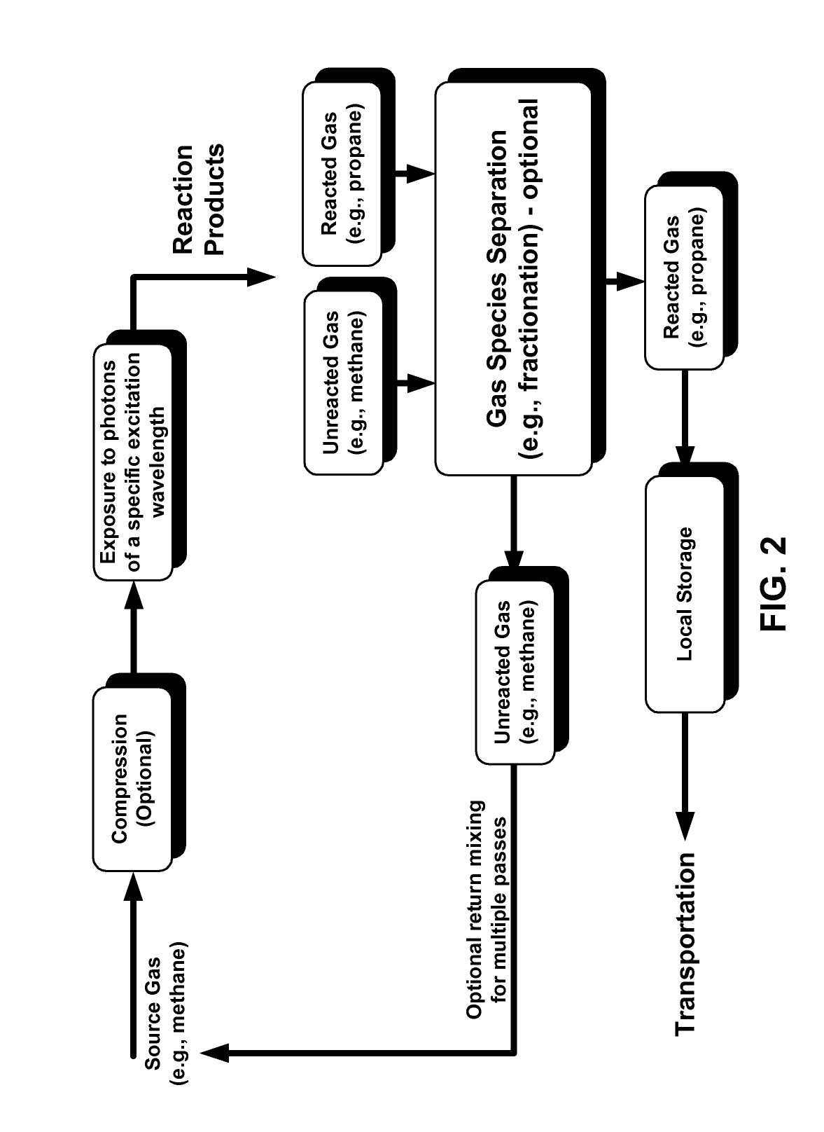

FIG. 2 illustrates a system for optically exciting methane gas molecules into a longer chain hydrocarbon, such as propane, in accordance with an embodiment of the present invention. It has been observed in the laboratory that methane molecules exhibit an excited state with a measurable lifetime when excited with monochromatic light at a wavelength of 421 nanometers (nm). It has been further observed that the excitation of methane molecules by photons of this wavelength is highly efficient, with efficiencies (number of excited molecules/number of photons) in excess of 50%. It has also been observed in the laboratory that such excited methane molecules react to form propane molecules.

Solid-state lasers present an attractive, compact option for creating a dense, high intensity illumination system for optical conversion of methane to propane. Unfortunately, lasers of the desired wavelength (421 nm) are not presently commercially available. However, a very inexpensive solid-state laser with a very close wavelength (405 nm) DOES exist and is used extensively in the commercial marketplace. The 405 nm lasers have a light emission spectrum that peaks at 405 nm, but all of the photons have slightly more energy than those of an ideal 421 nm laser. Since 405 nm photons have less than 3% MORE energy than the ideal laser, it was found that the low cost 405 nm lasers can be used to excite methane molecules. It was found that the small difference in energy off the peak absorption wavelength of 421 nm did not appreciably reduce the reaction rate of methane molecules to propane molecules. In fact, the net benefit of the commercially available laser more than compensated for any reduction in reaction efficiency due to wavelength detuning.

Therefore, in light of these observations, one embodiment of the present invention employs photons of wavelength 405 nm to optically excite methane molecules to a long lived excited state with a reduced activation potential. This causes the excited methane to react with and bond to other excited methane molecules, producing (in the observed embodiment) propane molecules.

There are many possible configurations for causing an input stream of gas (in the specific instance of FIG. 2, the input gas is methane) to be exposed to excitation light of a specific wavelength, and then separating the results into streams of the desired end product (such as propane) and unreacted gas. The end result can be sent on to a storage tank of some sort, and the unreacted gas can optionally be returned back to mix with the original input stream for an additional pass. This disclosure also presents a configuration in which a raw input stream is stored in a collection tank and later sent into an exposure station where the molecules are exposed to a specific wavelength of light. The result is a mixture of the desired end product and the source gas. These can be separated through standard means known to those skilled in the art, and the unreacted gas can then be returned to mix with the input stream for a second (or even third, fourth, etc.) pass.

What is claimed is:

1. A method for optical excitation of chemical species for enhanced chemical reaction, comprising:
providing a chemical to an illumination chamber;
illuminating the chemical with monochromatic light of a predefined wavelength, wherein the chemical is placed in an excitation state, and wherein the excitation state results in the molecules of the chemical being more likely to react with other molecules; and
providing the chemical in the excitation state to a reaction chamber, wherein the molecules of the chemical bond with other molecules in a predefined manner.
